(19) United States
(12) Patent Application Publication
(10) Pub. No.: US 2003/0063191 A1
(43) Pub. Date: Apr. 3, 2003

(54) Method and system for detecting and selecting foreground objects

(75) Inventors: Kiran Challapali, New City, NY (US); Alexander Kobilansky, Ossining, NY (US)

Correspondence Address: Corporate Patent Counsel, U.S. Philips Corporation, 580 White Plains Road, Tarrytown, NY, 10591, US

(73) Assignee: Philips Electronics North America Corp.

(21) Appl. No.: 09/969,713

(22) Filed: Oct. 3, 2001

(51) Int. Cl. H04N 7/18

(52) U.S. Cl. 348/135; 348/96

(57) ABSTRACT

A method and system are provided for detecting and selecting foreground objects from an acquired image. The system includes an image acquisition arrangement having a camera for acquiring an image and sources of illumination. The arrangement is augmented with an additional illumination device. The illumination device is positioned near the camera. The illumination device emits radiation, either in the infrared, visible, or ultraviolet range, which is detected by the camera. The radiation emitted by the illumination device differs from main ambient illumination by temporal and/or spectral properties so that it can be discriminated by the camera and/or other image processing devices. Foreground objects are recognized utilizing the image acquisition arrangement of the inventive system by using the temporal and/or spectral properties of the radiation emitted by the illumination device.

### BACKGROUND OF THE INVENTION

1. Technical Field

The present disclosure relates generally to image acquisition and processing, and more particularly, to a method and system for detecting and selecting foreground objects from an acquired image.

2. Background of the Related Art

Foreground objects, i.e., objects located closer to the observer, generally present the most important information in an image. A person typically starts studying content of an image from selecting foreground objects and analyzing them more carefully than background objects. Hence, efficient image processing, in particular, image compression, generally entails encoding foreground objects with more spatial and temporal details than background objects. The encoding of different objects (foreground versus background) at different levels of quality can be accomplished using compression standards, such as MPEG-4. As a result, recognizing and encoding foreground objects is one of the key elements in efficient image processing, especially image compression

Another application of recognizing and selecting foreground objects is in the selection and addition of a foreground object to a scene. This application is used by the motion picture and television production industries to create special effects, such as selecting a weather map and adding the weather map to a television screen shot, or selecting an animated character and adding the character to a live screen shot. A typical technique used for foreground object separation in the production industries is the use of blue or green shots in a studio environment.

Another approach for selecting foreground objects is to copy the object by utilizing a stereoscopic system employing the stereoscopic effect as known in the art. The stereoscopic system includes two properly oriented and focused cameras. However, the use of two cameras increases cost and decreases reliability of the system, which make the system unattractive for both consumer and professional applications. Another approach is to use a system which senses heat generated from a heat generating object, such as a person, to delineate the object as a foreground object. However, such systems generally detect the heat generating objects at low resolution and clarity. Further, these systems cannot be used to detect non-heat generating objects.

A need therefore exists for a method and system for detecting and selecting foreground objects from an acquired image which overcome the disadvantages of the prior art systems and methods.

### SUMMARY OF THE INVENTION

The present disclosure provides a method and system for detecting and selecting foreground objects from an acquired image. According to the present disclosure, the system of the present invention includes an image acquisition arrangement having a camera for acquiring an image and sources of illumination. The arrangement is augmented with an additional illumination device. The illumination device is positioned near the camera. The illumination device emits radiation, either in the infrared, visible, or ultraviolet range, which is detected by the camera. The radiation emitted by the illumination device differs from main ambient illumination by temporal and/or spectral properties so that it can be discriminated by the camera and/or other image processing devices. Foreground objects are recognized utilizing the image acquisition arrangement of the inventive system by using the temporal and/or spectral properties of the radiation emitted by the illumination device.

### BRIEF DESCRIPTION OF THE DRAWINGS

The invention is further explained by way of example and with reference to the accompanying drawings, wherein:

FIG. 1 is a block diagram of a system for detecting and selecting foreground objects from an acquired image according to a first embodiment of the present invention; and

FIG. 2 is a block diagram of a system for detecting and selecting foreground objects from an acquired image according to a second embodiment of the present invention.

### DETAILED DESCRIPTION OF PREFERRED EMBODIMENTS

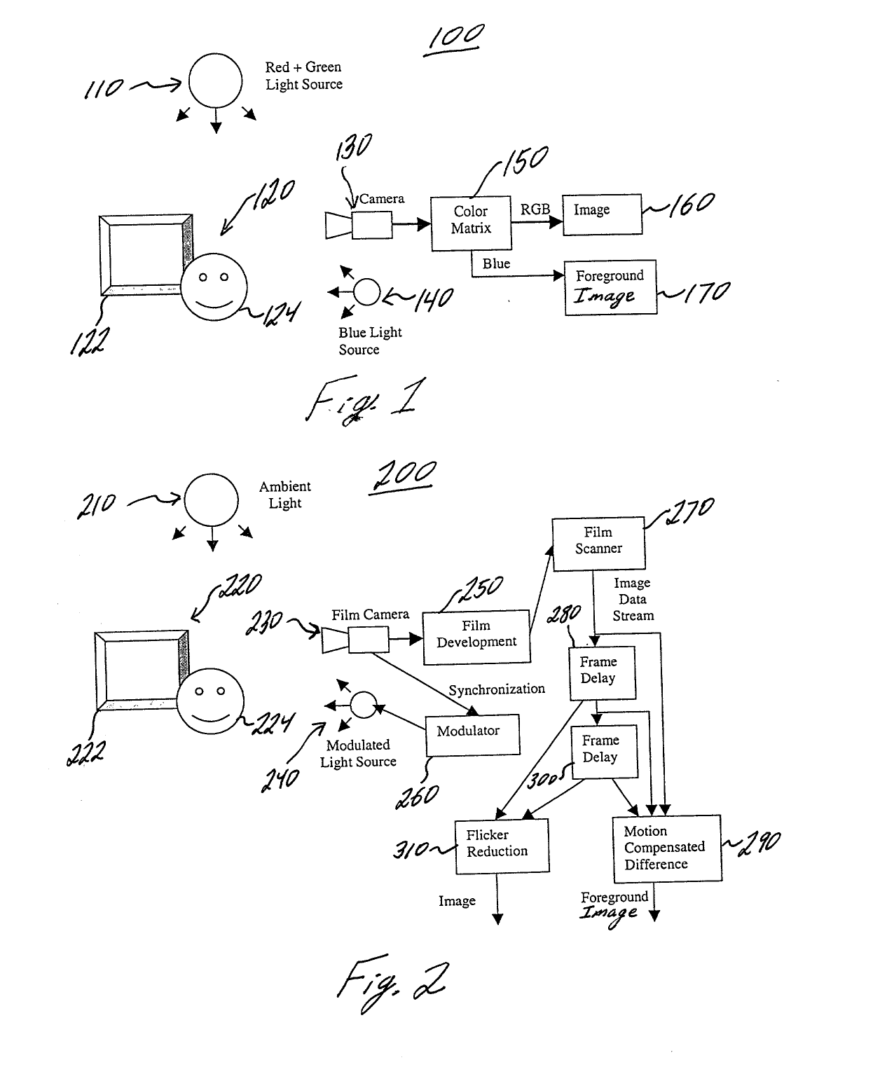

FIG. 1 is a block diagram of an exemplary system for detecting and selecting foreground objects from an acquired image according to a first embodiment of the present invention. The system is designated generally by reference numeral 100 and includes a red/green light source 110 (ambient illumination) for illuminating a scene 120 having a background image 122 and a foreground object 124. The system 100 further includes an RGB (red, green, blue) camera 130, e.g., a non-film camera, such as a television camera, or a film camera, aimed at the scene 120, and a small blue light source 140 (auxiliary illumination) located near the camera 130.

During operation, the camera 130 provides a signal to a color matrix processor 150 which processes the signal received from the camera 130. The color matrix processor 150 then generates an RGB image signal (designated RGB in FIG. 1) encoding an image 160 representing the red/green/blue portions of the scene 120, i.e., the image acquired by the camera 130 of the entire scene. The color matrix processor 150 also generates a blue signal (designated Blue in FIG. 1) encoding a foreground image 170 representing only the blue portions of the scene 120; specifically, the foreground object 124, since it is the only part of the scene 120 which is illuminated by the blue light source 140. Accordingly, the system 100 automatically recognizes and identifies the foreground object 124 based on a color, i.e., spectral, difference between an auxiliary light source, i.e., the blue light source 140, and an ambient light source, i.e., the red/green light source 110, using a non-film camera.

It is appreciated by one skilled in the art that any type of ambient light source can be used in the system 100 besides the red/green light source 110 and any type of auxiliary light source can be used besides the blue light source 140, as long as the two light sources are spectrally different. For example, the ambient light source can be a blue light source and the auxiliary light source can be an infrared light source, since light emitted by the blue light source is spectrally different from light emitted by the infrared light source.

FIG. 2 is a block diagram of an exemplary system for detecting and selecting foreground objects from an acquired image according to a second embodiment of the present invention. The system is designated generally by reference numeral 200 and includes an ambient light source 210 for illuminating a scene 220 having a background image 222 and a foreground object 224. The system 210 further includes a camera 230, e.g., a film camera, such as a home video camera capable of recording a scene on a videocassette, or a non-film camera, such as a television camera, aimed at the scene 220, and a modulated light source 240 located near the camera 230.

During operation, the film camera 230 takes motion pictures of the scene 220 and records the motion pictures on a film. The film is then provided to a film development device 250. The film camera 230 also provides a synchronization signal to a modulator 260 which modulates the light source 240 in accordance with the synchronization signal. This enables the film camera 230 to be in sync with the modulator 260, in order for the light source 240 to illuminate (or not illuminate) the scene 220 when the film camera 230 takes motion pictures of the scene 220.

The film development device 250 processes the film and provides the processed film to a film scanner 270 which scans the film to generate digital images of the scene 220. The digital images include a plurality of frames which are transmitted as a data stream to a first frame delay 280 which delays each frame with respect to every other frame by a first predetermined delay. The first predetermined delay is preferably equal to a frame time. For example, if 24 frames are transmitted per second, then the frame time is equal to 1/24th of a second. The data stream is also transmitted to a motion compensated difference device 290.

After the first frame delay 280, each delayed frame is transmitted to a second frame delay 300 which delays each frame with respect to every other frame by a second predetermined delay. The second predetermined delay is preferably also equal to the frame time. After the first and second delays 280, 300, each delayed frame is transmitted to the motion compensated difference device 290 and a flicker reduction device 310.

In the system 200, each frame is distinguished by an adjoining contiguous frame by the modulated light source 240. That is, each frame tends to be darker or lighter than a succeeding (or preceding) frame according to the synchronization signal provided to the modulator 260 which modulates the light source 240. Within the lighter frames, the amount of illumination illuminating the foreground object 224 is higher than the amount of illumination illuminating the background image 222, since the modulated light source 240 adds additional illumination to the foreground object 224. Subsequently, an illumination difference between adjoining contiguous frames is detected by the motion compensated difference device 290 by comparing the illumination of adjacent frames. Further, due to the higher illumination of the foreground object 224, it is detected by the motion compensated difference device 290, whereas the background image 222 gets subtracted out.

Generally, objects tend to change position slightly or move as the film progresses from one frame to the succeeding frame. Therefore, a simple difference between adjacent frames results in the detection of both areas of higher illumination (corresponding to foreground object 224) and changes due to the movement. The motion compensated difference device 290 analyzes the frames and determines any objects which have changed position or have moved as the film progresses from one frame to a succeeding frame of the plurality of frames. The motion compensated difference device 290 then compensates for the movement of objects within a frame before detecting an illumination difference with an adjacent frame. Thereby, only differences due to higher illumination (corresponding to foreground object 224) are detected.

The motion compensated difference device 290 then outputs an image of the foreground object 224. The flicker reduction device 310 receives as inputs the frames following the first and second delays 280, 300, reduces the flickering caused by the modulated light source 240 and outputs an image of the scene 220. The outputted image is the image of the scene 220 acquired by the camera 230. Accordingly, the system 200 automatically recognizes and identifies the foreground object 224 based on temporal modulation using motion film.

Preferably, for the systems 100 and 200 the size of the illumination device 140, 240 and their distance from the cameras 130, 230 should be less or comparable to a typical distance between the cameras 130, 230 and the foreground objects 124, 224 in the scenes 120, 220.

It will be understood that various modifications may be made to the embodiments disclosed herein and that the above description should not be construed as limiting, but merely as exemplifications of preferred embodiments. Accordingly, those skilled in the art will envision other modifications within the scope and spirit of the claims appended hereto.

What is claimed is:

1. An image acquisition and processing system comprising:
a camera for acquiring an image of a scene having a background and at least one foreground object;
a light source in proximity to the camera; and
a processing system having means for receiving the acquired image of the scene from the camera and means for separating the at least one foreground object from the background by using one of the spectral and temporal properties of the light source.

2. The system according to claim 1, wherein the camera is one of a non-film and a film camera.

3. The system according to claim 1, further comprising an ambient light source for illuminating the scene.

4. The system according to claim 3, wherein the light source emits light which is spectrally different from light emitted by the ambient light source.

5. The system according to claim 1, wherein the light source is a modulated light source.

6. The system according to claim 1, wherein the processing system comprises:
color matrix processor comprising:
means for processing the acquired image; and
means for generating a signal indicative of the scene and a signal indicative of at least one portion of the scene illuminated by the light source; and
output means for outputting an image of the scene and an image of the at least one foreground image.

7. The system according to claim 6, wherein the means for generating the signal indicative of the scene and the signal indicative of at least one portion of the scene illuminated by the light source includes means for determining a spectral difference between an ambient light source illuminating the scene and the light source.

8. The system according to claim 1, wherein the processing system comprises a modulator for modulating the light source.

9. The system according to claim 8, wherein the modulator modulates the light source in accordance with a synchronization signal received from the camera.

10. The system according to claim 1, wherein the processing system comprises:
a film development device for processing a film resident within the camera and having been used by the camera to record the acquired image of the scene;
a film scanner for scanning the film for generating digital images of the scene, wherein the digital images include a plurality of frames; and
a delay device for receiving the digital images and delaying each scanned frame with respect to every other scanned frame by at least one predetermined delay.

11. The system according to claim 10, wherein the delay device includes first and second delay devices for providing first and second delayed frames, respectively, of the at least one delayed frame.

12. The system according to claim 10, further comprising a motion compensated difference device having means for analyzing at least one delayed frame with respect to a non-delayed frame for determining whether any objects within the scene have changed position.

13. The system according to claim 10, further comprising a motion compensated difference device having means for determining an illumination difference between adjacent frames of the plurality of frames and means for outputting as the at least one foreground object an image of at least one object which has a higher illumination than other objects in the scene.

14. The system according to claim 10, wherein each frame of the plurality of frames is distinguishable from an adjoining contiguous frame of the plurality of frames by an amount of illumination provided by the light source.

15. The system according to claim 10, further comprising a flicker reduction device comprising:
means for receiving at least one frame outputted by the delay device;
means for reducing flickering from the at least one frame caused by modulating the light source; and
means for outputting an image of the scene.

16. A method for acquiring and processing an image, the method comprising the steps of:
acquiring an image of a scene having a background and at least one foreground object using a camera;
illuminating the scene with a light source; and
processing the acquired image of the scene by separating the at least one foreground object from the background by using one of the spectral and temporal properties of the light source.

17. The method according to claim 16, wherein the camera is one of a non-film and a film camera.

18. The method according to claim 16, further comprising the step of providing an ambient light source for illuminating the scene.

19. The method according to claim 18, wherein the light source emits light which is spectrally different from light emitted by the ambient light source.

20. The method according to claim 16, wherein the light source is a modulated light source.

21. The method according to claim 16, further comprising the steps of:
generating a signal indicative of the scene and a signal indicative of at least one portion of the scene illuminated by the light source; and
outputting an image of the scene and an image of the at least one foreground image.

22. The method according to claim 21, wherein the generating step includes the step of determining a spectral difference between an ambient light source illuminating the scene and the light source.

23. The method according to claim 16, further comprising the step of modulating the light source.

24. The method according to claim 23, wherein the step of modulating the light source modulates the light source in accordance with a synchronization signal received from the camera.

25. The method according to claim 16, wherein the processing step comprises the steps of:
processing a film resident within the camera and having been used by the camera to record the acquired image of the scene;
scanning the film for generating digital images of the scene, wherein the digital images include a plurality of frames; and
delaying each scanned frame with respect to every other scanned frame by at least one predetermined delay.

26. The method according to claim 25, further comprising the step of analyzing at least one delayed frame with respect to a non-delayed frame for determining whether any objects within the scene have changed position.

27. The method according to claim 25, further comprising the steps of:
determining an illumination difference between adjacent frames of the plurality of frames; and
means for outputting as the at least one foreground object an image of at least one object which has a higher illumination than other objects in the scene.

28. The method according to claim 25, further comprising the step of distinguishing each frame of the plurality of frames from an adjoining contiguous frame of the plurality of frames by an amount of illumination provided by the light source.

29. The method according to claim 25, further comprising the step of reducing flickering from at least one frame of the plurality of frames caused by modulating the light source.

30. The method according to claim 29, further comprising the step of outputting an image of the scene.
